(19) United States
(12) Patent Application Publication
(10) Pub. No.: US 2013/0237139 A1
(43) Pub. Date: Sep. 12, 2013

(54) METHOD FOR TESTING THE AIR QUALITY IN AN OPERATING ROOM

(71) Applicant: Rupert MACK, Fernwald (DE)

(72) Inventor: Rupert MACK, Fernwald (DE)

(21) Appl. No.: 13/779,931

(22) Filed: Feb. 28, 2013

(30) Foreign Application Priority Data
Mar. 6, 2012 (EP) 12158301.7

(51) Int. Cl. G01N 1/22; A61G 10/02; A61G 13/10

(52) U.S. Cl. CPC G01N 1/2273; A61G 13/108; A61G 10/02
USPC 454/187; 454/256; 73/31.02

(57) ABSTRACT

The invention relates to a method for testing and/or monitoring the air quality in an operating room (100) with an operating table (110) arranged in it. In order to achieve conclusions about the air quality with simple measures it is suggested that at least one measured value recorder (118, 120, 122, 123) is arranged in, on and/or in the range of the operating table by means of which the air quality of the air is measured in the area of the operating table and during the activities.

This application claims priority to European patent application number EP 12 15 8301.7, filed Mar. 6, 2012, the contents of which are incorporated herein by reference.

The invention relates to a method for testing and/or monitoring the air quality in an operating room with an operating table present in it with a wound area provided on the table as well as with at least one instrument table.

The invention also relates to a method for conditioning the air in a room, especially a clean room such as an operating room to which a downward flow, in particular a low-turbulence or laminar downward flow is supplied over a working area such as a protected area of an operating table.

It should be ensured in operating rooms that boundary values, defined under working conditions, of the concentration of airborne contamination are observed.

A low-turbulence or laminar downward flow should be ensured in operating rooms with a low-turbulence displacement flow for achieving a protected area in which the operation takes place and the instrument tables are positioned. This largely avoids a turbulence of the air in the operating area and the germ-free supplied air flowing into the operating area from the OP ceiling is guided in a purposeful manner in the direction of the floor.

In the case of an improper behavior such as, e.g., a vigorous movement of persons in the area of the operating area and/or an improper arrangement of devices turbulences can occur in the supplied air that can result in a higher risk of a contamination and thus endanger the person to be operated on. This can be expressed, e.g., by infections occurring at a later time.

In order to make possible a three-dimensional, time-dependent measuring of the amount and the direction of the speed and the degree of turbulence of an air flow a thermal anemometer in accordance with DE-A-103 24 724 is suggested.

In order that turbulences can be made visible in a medical area according to DE-A-44 05 986 a sound constructed as a distributor lance with a lance head is suggested that comprises a pressure chamber connected to an aerosol generator and comprises an outflow chamber.

DE-A-197 02 662 has as subject matter an air-conditioning thermal anemometer that is used for measuring the flow in a room of a building.

DE-A-26 00 359 describes a device for automatically controlling a ventilator device for a room as a function of its temperature, particles floating in the air or the atmospheric humidity.

A measuring of toxic components in a room and a control for removing them is known from JP-A-04135647.

DE-A-100 58 720 relates to a flow sensor intended in particular for breathing apparatuses and anesthesiology apparatuses.

DIN 1946-4 relates to room-air systems in hygienic buildings and rooms. Methods can be gathered from the DIN for making it possible to qualify an OP room. Measurements of the degree of turbulence and of the degree of protection are indicated as methods. The standard also applies in this case for the planning, construction and the removal of room-air systems, whereby the minimum extent of a technical removal check is indicated in table 2. After the removal an operating room can then be put in operation without further measurings taking place.

The present invention has the basic task of further developing a method of the initially cited type in such a manner that the air to be supplied in an operating room has a quality that avoids or at least reduces the endangering of a person to be operated on. An ensuring of the quality of the air quality prevailing in the area of an operating table should be made possible. A high flexibility should be given in order to make possible influences in the further environment of the wound area as well as in its immediate area.

In order to solve the task the invention substantially provides that at least one measured value recorder is arranged at least in the area of the wound area or of an area standardized like it, by means of which recorder an air quality parameter representing the air quality is measured.

It is provided in particular that the measured value recorder arranged in the area of the wound area is arranged in an operating lamp arranged above the wound area or on the supply to the lamp. This ensures that the personnel is not hindered by the measured value recorder. Also, constructive changes in the area of the operating table are not necessary. In particular, the measured value recorder is arranged on the side or on the back side of the operating lamp.

As a result thereof, measured values are determined that that make possible qualitative statements about the air quality in the area of the wound area, if necessary by previously performed calibrations.

The indication “area standardized like the wound area” means that measurements can be also made at a fairly large distance from the wound area, whereby conclusions about the quality of the air in the area of the wound area can be made taking into account, e.g., calibration values or experimental values. In other words, measurements can be made in an area of the operation room that might be at a considerable distance from the wound area if necessary but offer the possibility on account of, e.g., stored measured values of making statements about the air quality in the area of the wound area. To this extent the concept “wound area” is also be understood in the following in the sense of a standardized area.

A further development provides that in addition to or alternative to the particles contained in the air permeating the measured value recorder even the number of germs is measured and/or counted, i.e., a distinction is made between germ-carrying particles and dead particles. A regulating or control of the air to be supplied to the operating room can then take place as a function of the number of germ-carrying particles or air-carried particles. A control can then take place if threshold values are reached or dropped below.

It is provided in particular that at least one other measured value recorder is arranged on, at or in the area of the at least one instrument table. If several instrument tables are present then each instrument table can have a measured value recorder.

In order to achieve a high flexibility there is the possibility of arranging the measured value recorder where there is the danger that the air quality is being negatively influenced. This can also be the case in the area of an operating surgeon or of some other person present in the operating room.

This possibility is created in particular in that air is drawn through hoses at the measuring location, whereby each hose can be connected to a separate measuring sound or several hoses can be connected to a common measuring sound.

The hose openings drawing the air in are positioned at locations where a measuring is to be carried out. This results in a high flexibility and therefore ensures that the quality of the air flowing in the wound area has the required quality.

In particular, it is provided that at least one parameter representing the air quality and from the group of air speed, turbulence, temperature, particle concentration and/or germ concentration is measured by the measured value recorder(s). In particular, the particle concentration is significant since the particles in the air can cause concretions in the tissue and/or are paths for germs. Thus, it must be excluded that a high number of particles are present in the wound area. If an inadmissibly high number can be determined, a supplying of additional air brings about a diluting effect and therefore a reduction of the concentration.

According to the invention in the case of need a differentiation between “dead” and “living” particles can take place. “Living particles” means that the particles are charged with germs. Then, a change of the air to be supplied to the operating room takes place to the extent required as a function of particles occupied by the corresponding germs.

According to the invention a dynamic monitoring—a continuous measuring or a measuring taking place according to a time pattern—of the air quality can take place. For this, in particular a measured value recorder is arranged in the immediate area of the wound area, whereby the maximum distance between the measured value recorder and the wound area is preferably approximately the interval between the wound area and the operating lamp illuminating the wound area, approximately 50 cm-100 cm. The same applies if instead of a measuring sound air is aspirated via a hose or a line. The interval is then the interval between the outlet opening and the wound area. If the measured value recorder or the supply to the measured value recorder like a hose does not start from the operating lamp, the interval should then preferably be in a range of 30 cm-50 cm. However, the invention is not departed from if greater intervals are selected, whereby the air quality parameters are standardized if necessary in order to be able to determine the air quality in a reproducible manner independently of the distance. This can take place by previous calibration steps or measurements.

There is also the possibility of integrating several measured value recorders, that is, openings of hoses, into the operating table or of fastening them onto it. The same applies to instrument tables or other apparatuses present in the operating room. This also includes clothed operating personnel.

If the particle concentration is preferably selected as the air quality parameter, a measuring of the degree of protection can also be carried out by at least one measured value recorder, as is provided in connection with the removal of an operating room according to DIN 1946-4, attachment C.

According to the invention the air quality is measured with the aid of characteristic parameters in accordance with the requirements of the operating room and/or of the wound area in order to carry out a regulating or control of the air in the case of inadmissible, such as elevated measuring values, in such a manner that the measured parameters are within given boundary values. Of course, there is also the possibility of measuring more than one air quality parameter at the same time, if necessary at different measuring positions.

According to the invention a measuring takes place and optionally an improving of the air.

In particular, it is provided that the air quality and/or one or more air quality parameters are measured online and then the measured actual value is compared with a theoretical value. If the theoretical value is exceeded a signal can be generated. In addition to or instead of the signal a control, but in particular a regulation can take place in such a manner that the developing actual value is in the theoretical value range.

Furthermore, the invention comprises the concept that the turbulence is measured online and upon an exceeding of a fixed degree of turbulence of, e.g., 30% a signal is generated and/or air flowing into the operating room is regulated, e.g., according to the direction and/or amount and/or type of flow.

An adaptive system takes place that ensures that an optimal air quality prevails in the area of the operating table and especially in the area of the wound area.

A further development of the invention provides that the air quality parameter measured by the at least one measured value recorder is stored. An archiving of the measured results can take place in order to be able to then compare these results with data from, e.g., consequences of the operation.

According to the invention a measuring, improving and archiving take place.

A method for conditioning the air in an operating room with operating table, to which room directed, low-turbulence or laminar-flowing air is supplied is distinguished in that at least one measured value recorder that measures the degree of turbulence of the flowing air and/or the number of particles in the air is arranged in the area of the operating table, especially in the area of a wound area of a patient lying on an operating table, and that the flowing air is regulated as a function of the measured degree of turbulence. In particular, the speed and the volume of the supplied air is regulated.

If the degree of turbulence is measured, a sensor is immediately arranged on the measuring site that can determine the degree of turbulence. Appropriate sensors are known from the state of the art. In so far, for example, reference is made to measuring sounds of the TESTO AG, Lenzkirch, Germany.

The same applies regarding the air quality parameters, air speed and temperature.

As regards the measuring of the particle concentration and/or measuring the germ number, it is sufficient if air is drawn off at a measuring site, as was previously explained.

It is provided in another embodiment of the invention to be emphasized or according to an inventive aspect that air quality parameters determined by several measured value recorders are averaged and the corresponding value is used as a correcting variable for regulating or controlling the air to be supplied to the operating room, whereby in particular the air quality parameter value measured in the area of the wound area is weighted with a factor F with F>1.

It is ensured by the average value as regulating magnitude that the air in the operating room has the required quality. However, in order to ensure in particular in the area of the wound area that there is a lesser quality in this area, in particular when measuring the particle concentration, a too high concentration of particles transporting possible germs, the measured value for the wound area or the measured values determined in the area of the wound area can be weighted with a factor greater than 1.

A further development provides that if the measured value or the measured values in the area of the wound area exceed an inadmissible value, a regulating or controlling of the air to be supplied to the operating room takes place exclusively as a function of the air quality parameter value measured in the area of the wound area.

If there is the possibility that the air quality parameter or parameters are determined at measuring positions that can change their location, of course even stationary measuring positions can be used or a mixture of stationary measuring positions and measuring positions that can change their location. A positioning on an OP lamp or a supply to the latter is preferred. To this extent the positioning is also to be understood as one in the area of the wound area.

It is provided independently of this and in an embodiment of the invention that is to be emphasized that given several measuring positions arranged distributed in the operating room those are selected that are evaluated as relevant as regards the type of the wound area and the size of the wound area in order to then carry out the regulating and/or controlling of the air to be supplied to the operating room on the basis of the measured values determined by the selected measuring positions. The type of the wound area also includes the duration of an operation so that consequently a change of OP personnel or the number of the personnel must be included even indirectly in the determination and evaluation of the air quality.

Furthermore, it should be stressed that the evaluation of the selected parameter characteristic for the air quality can take place as a function of an operation to be carried out since different room air classes are given for different operations. Thus, e.g., for operations of burn injuries or, e.g., heart and bone operations the room air class 1a) is given and for operations in the neck/nose/ear area the room class 1b) is given. Thus, an evaluation takes place as a function of the type of operation and thus of the type of the wound area.

Further details, advantages and features of the invention result not only from the claims, the features to be gathered from them—alone and/or in combination—, but also from the following description of preferred exemplary embodiments to be gathered from the drawings.

In the drawings:

FIG. 1 shows a first basic view of an operating room,

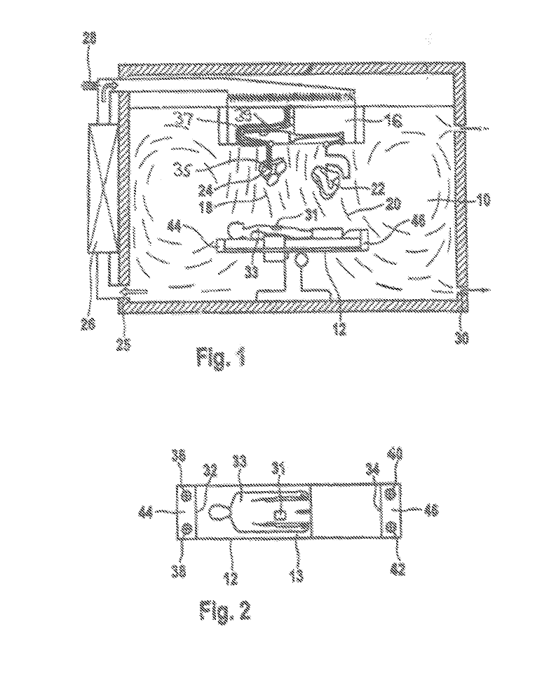

FIG. 2 shows a top view onto an operating table, and

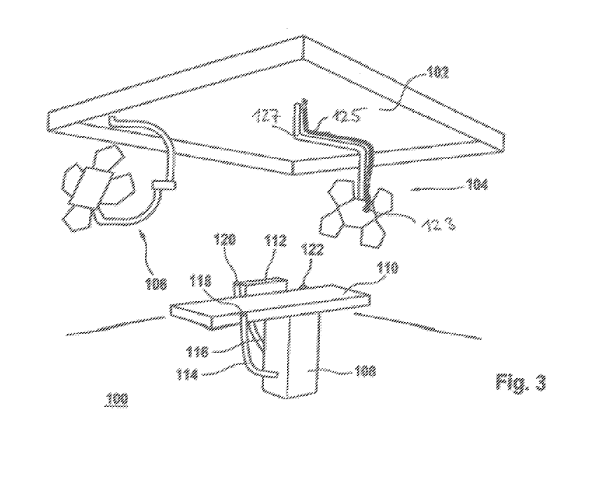

FIG. 3 shows a second basic view of an operating room.

The teaching of the invention is explained in the FIGS. 1 and 2 using a measured value recorder of the degree of turbulence as an air quality measured value recorder without this limiting the teaching of the invention, but rather the corresponding data is to be understood as a synonym for parameters that determine the air quality.

In particular, measured value recorders or sounds with which the number of particles and/or germs can be counted are also to be understood as synonyms.

Independently of the above, instead of measured value recorders the concept measuring sound is also used in the following that is to be understood as technically equivalent in as far as at least one value characteristic for the air quality is detected and/or determined. The concept measured value recorder also includes the concept of the openings such as hose openings via which the air is aspirated and then supplied to a measuring sound in order, e.g., to determine the number of particles in the air, that is, the particle concentration. This is especially important since particles are vehicles for germs, so that it must be ensured that so few particles and germs carried by them in the air as possible can pass into the wound area of a patient to be operated on.

FIG. 1 shows a basic operating room 10 in which a laminar, low-turbulence downward flow is supplied to an operating table 12 via a parallelepipedic body of a ceiling air supply 16, as is indicated by the arrows 18, 20. Operating lamps 22, 24 are arranged in the area of the air exit opening and are aerodynamically designed in such a manner that an elevation of the turbulence takes place only to a slight extent.

As results from the arrows, an air circulation system with an external air component is provided in the operating room 10, i.e., a part of the air is removed via an opening 25 present in the bottom area and is then returned to the operating room 10 via an air-conditioning device 26. If outside air is supplied via an opening 28 a corresponding amount of the air is removed from the operating room 10 via another opening 30. Refer, however, in this regard to sufficiently known technologies.

The air supplied via the ceiling air supply 16 and therefor to the body is germfree in order to avoid infections in a patient to be operated.

In order that as little contaminated air as possible passes by induction into the operating area, i.e., wound area 31 to a person 33 to be operated on or already operated on as well as to his environment, instrument tables and sterilely clothed OP personnel, care must be taken that the laminar or low-turbulence downward flow 18, 20 also remains maintained during the operation. In order to carry out a test in this regard the invention provides that, e.g., measuring sounds 36, 38 and 40, 42 are arranged in the particular front end 32, 34 of the operating table 12 via which sounds the degree of turbulence is measured in the sense of the above explanations. The measuring sounds 36, 38, 40, 42 are preferably integrated in attachments 44, 46 connected in the particular front edge areas 32, 34 to the operating table. Thus, the lying surface 13 of the operating table 12 is not reduced by the measuring sounds 36, 38, 40, 42. Of course, the sounds 36, 38, 40, 42 can also be directly integrated or built into the operating table 12.

The sounds and the openings of the lines or hoses running to the sounds are preferably located in the area of the OP lamps 22, 24. Thus, e.g., a sound 35 can be arranged in the edge area of the OP lamp 24. To this extent the sound 35 is to be understood as arranged in the area of the wound area. However, there is also the possibility of providing sounds or openings of lines or hoses running to the sounds on the back side of one or both operating lamps 22, 24.

A standardization can take place as a function of the position of the sound by means of which conclusions can be drawn about the air quality in the immediate area of the wound area 31. This can take place by previously performed calibrations. If a line or a hose 37 runs to a sound such as the sound 35, it can be run along the linkage 39 of the OP lamps 22, 24 via which the operating lamps 22, 24 are suspended from the ceiling of the OP room 10 and via which the OP lamp, i.e., the head comprising the illuminating means, can be adjusted into desired positions. The hose 37 or an appropriate line can have in inside diameter between 6 mm and 8 mm.

However, the sounds measuring the air quality can also be provided in other areas of the operating room 10, e.g., in the area of instrument tables, that also include suspended instrument receptacles, or in the areas in which the operation personnel are preferably located, in order to name only a few preferred measuring positions by way of example.

The measuring sounds are in particular like the ones offered by TESTO AG, Lenzkirch, Germany.

The degree of turbulence can be determined by the air flow loading the measuring sounds 36, 38, 40, 42 with the consequence that in the case of inadmissible turbulence, e.g., a signal such as an acoustic or optical signal is generated in order to indicate to the medical personnel that inadmissible turbulences are occurring that, are produced, e.g., by movement of the personnel and/or by false positioning of device tables and/or by false positioning of devices present above the operating table 12 such as the operating lamps 22, 24. By way of supplementation or alternatively the air flowing from the ceiling air supply 16 over the body 14 can be influenced as a function of the measured degree of turbulence in that, e.g., the amount of air and/or the air speed is/are changed in order to reduce the turbulences. A regulation takes place.

This ensures a creation of quality that makes it possible that desired low-turbulence, laminar downward flows onto the operating area occur in the operating area.

Another basic view of an operating room 100 can be gathered from FIG. 3 from the ceiling 102 of which operating lamps 104, 106 are suspended. An operating table 110 extending from a column 108 is located in the middle of the operating room.

In the exemplary embodiment hoses 114, 116 run out from the column 108 that end with their openings 118 and 120 in the area of the operating area, that is, on the top of the operating table 110 or in the area of the instrument table 112 in order to be able to draw in air over it. Furthermore, another opening 122 is shown that is positioned directly in the area of a wound area of a patient to be operated on. The distance between the opening 122 and the wound area is preferably not more than 30 cm.

The hoses are run to a measuring sound in order to measure the air drawn in via the openings 118, 120, 122 regarding the particle concentration. There is the possibility here that each opening 118, 120, 122 can be designated in so far as a measured value recorder and is connected to a separate measuring sound or the hoses or a desired number of hoses are connected to a common measuring sound.

If three measured value recorders with openings 118, 120, 122 are shown by way of example in FIG. 3, a greater number can be provided in the operating room 100. Also, the positioning of appropriate measured value recorders can take place where an influencing of the air flowing into the operating room 100 that flows down from the ceiling 112 in the direction of the operating table 110 in a laminar, low-turbulence manner can be suspected. This makes available a highly flexible system for monitoring the air quality in the operating room 100, whereby in order to influence or regulate the air flowing into the operating room 100 the air drawn off via the openings 118, 120, 122, that is, measured value recorders, and the concentrations of particles and/or germs that are then determined can be evaluated in order to obtain a correcting variable with which the air supply is influenced. In particular, the measured value of the measured value recorder, that is, of the opening located in the immediate vicinity of the wound area, can be weighted, as a result of which it is additionally ensured that the air supplied in the area of the wound area meets the necessary quality requirements.

Furthermore, FIG. 3 shows that a measuring sound 123 is fastened directly on the operating lamps 104 in order to draw in air and to determine a parameter in order to be able to make a statement about the air quality. In particular, the particle concentration is determined, whereby the number of particles that are charged with germs are counted separately if necessary. Also, a comparison can be made between the total number of particles and the number of particles charged with germs. This results in conclusions about the air quality in the area of the wound area.

According to the presentation in the drawings a line 125 that runs along the linkage 127 of the operating lamp 104 runs to the measuring sound 123. It is also pointed out once more in this connection that the concept “measuring sound” also includes the fact that the line 125—e.g., in the area of the operating lamp 104, i.e., of its lamp housing—has an opening 125 in order to draw in air through it via the line 125 that then arrives at a measuring sound connected to the line 125. Arranging the measuring sound in the area of the wound area then means the arranging of the outlet opening in the area of the wound area.

There is also the possibility of fastening appropriate hoses directly on the clothing of operating personnel in order to detect influences by the operating personnel.

Furthermore, there is the possibility of archiving the measured measured values in order to be able to then compare them with consequences of the operation in order to thus draw conclusions about whether they could have been caused at least in part by the air quality prevailing during the operation, which can also include the degree of turbulence.

As was explained earlier, measured values can be archived in order to test at a later time to what extent one or more parameters determining the air quality could have influenced, e.g., a healing process during an operation. According to the invention a dynamic monitoring takes place that therefore measures the parameters during the operation and archives them to the desired extent.

As a result of the measuring of the parameters during the operating a regulating of the parameters can take place as a function of the measured actual values for subsequent regulation in accordance with given theoretical values or theoretical value ranges. For this the number of measuring sounds required for determining the air parameters are connected to a control via which the necessary regulating takes place.

What is claimed is:

1. A method for testing and/or monitoring the air quality in an operating room with an operating table present in it with a wound area provided on the table as well as with at least one instrument table, wherein at least one measured value recorder is arranged at least in the area of the wound area or of an area standardized like the wound area, by means of which recorder an air quality parameter representing the air quality is measured.

2. The method according to claim 1, wherein at least one measured value recorder is arranged on and/or in the area of the instrument table.

3. The method according to claim 1, wherein in order to determine the at least one air quality parameter representing the air quality, this parameter is measured in the area of an operating lamp present in the operating room.

4. The method according to claim 1, wherein at least one parameter representing the air quality and from the group of air speed, turbulence, temperature, particle concentration particle number with and/or without germ load is measured by the measured value recorder or recorders.

5. The method according to claim 1, wherein one or more air quality parameters is/are measured online and the parameter or parameters measured with the at least one measured value recorder is/are regulated by regulating the air to be supplied to the operating room in such a manner that a determined actual value is in the range of a theoretical value.

6. The method according to claim 1, wherein the air to be supplied into the operating room is regulated as regards speed and/or amount or volume as a function of the measured, at least one air quality parameter.

7. The method according to claim 1, wherein the at least one air quality parameter measured by the at least one measured value recorder is stored, in particular stored for the duration of an operation, and is archived and compared with data of consequences of operations.

8. The method according to claim 1, wherein air quality parameters determined by several measured value recorders are averaged and a corresponding value is used as a correcting variable for regulating or controlling the air to be supplied to the operating room.

9. The method according to claim 1, wherein the air quality parameter value measured in the area of the wound area is weighted with a factor F with F>1.

10. The method according to claim 1, wherein regulation or controlling of the air to be supplied to the operating room takes place exclusively as a function of the air quality parameter measured in the area of the wound area or of the area standardized like it if the measured value exceeds a boundary value.

11. The method according to claim 1, wherein the at least one air quality parameter is measured at at least one measuring position that can change its location, preferably at several measuring positions that can change their location.

12. The method according to claim 1, wherein measuring positions relevant for the type of the wound area are selected from several measuring positions arranged distributed in the operating room and that the at least one air quality parameter determined in these selected measuring positions is used to regulate or control the air to be supplied to the operating room.
